(19) United States
(12) Patent Application Publication
(10) Pub. No.: US 2012/0084011 A1
(43) Pub. Date: Apr. 5, 2012

(54) METHODS FOR MANAGING CANCER PATIENT CARE

(75) Inventors: Robert G. Uzzo, Ambler, PA (US); Alexander Kutikov, Voorhees, NJ (US)

(73) Assignee: Fox Chase Cancer Center, Philadelphia, PA (US)

(21) Appl. No.: 13/248,444

(22) Filed: Sep. 29, 2011

Related U.S. Application Data
(60) Provisional application No. 61/388,120, filed on Sep. 30, 2010.

(51) Int. Cl. G06F 19/00

(52) U.S. Cl. 702/19

(57) ABSTRACT

Methods for managing the care of a cancer patient are provided. Generally, the methods comprise calculating a risk score from characteristics obtained from a cancer patient with a plurality of nomograms comprising the characteristics and a plurality of competing risk factors, using a program to calculate risk scores; determining the patient's prognosis based on the risk score; and treating the patient with a regimen capable of improving the prognosis of a cancer patient having substantially the same risk score. Systems and computer readable media for practicing the methods are also provided.

### CROSS REFERENCE TO RELATED APPLICATIONS

This application claims priority to U.S. Provisional Application No. 61/388,120 filed on Sep. 30, 2010, the contents of which are incorporated by reference herein, in their entirety and for all purposes.

### STATEMENT OF GOVERNMENT SUPPORT

The inventions described herein were made, in part, with funds obtained from the National Institutes of Health, Grant No. P30 CA 06927. The U.S. government may have certain rights in these inventions.

### FIELD OF THE INVENTION

The invention relates generally to the field of personalized medicine. More particularly, the invention relates to methods for managing the care of and for improving the prognosis of cancer patients, preferably genitourinary cancer patients.

### BACKGROUND OF THE INVENTION

Various publications, including patents, published applications, technical articles and scholarly articles are cited throughout the specification. Each of these cited publications is incorporated by reference herein, in its entirety and for all purposes.

Incidentally detected kidney cancer is common, particularly in older adults. Despite increasing early detection of renal cell carcinoma (RCC) and high rates of extirpative surgery, mortality rates from RCC have continued to increase, suggesting that despite the aggressive and lethal nature of some renal tumors, some localized masses pose little risk to longevity in the short or intermediate terms.

Accurate prediction of an individual's renal mass biology is highly desirable. This is especially critical in elderly or comorbid patients in whom surgery poses significant risks. It is believed that competing risk analyses for genitourinary cancers, such as RCC, have not been undertaken. Instead, as with many solid tumors deemed high risk, treatment trade-off calculations remain qualitative and subject to practitioner biases. Although attempts to stratify by performance status or comorbidity indices are valuable, they fail to quantitate competing risks of death versus the index cancer.

To improve the outcomes for genitourinary cancer patients, it is desirable to consider competing risks in order to more accurately determine a patient's prognosis, to facilitate better patient counseling, and to develop a personalized treatment plan capable of improving the prognosis.

### SUMMARY OF THE INVENTION

The invention features methods for managing the care of cancer patients. The methods may be used to manage the care of a patient having any type of cancer, and managing the care of genitourinary cancer patients is highly preferred. In general, the methods comprise calculating a risk score from characteristics obtained from a cancer patient, for example, from a genitourinary cancer patient, by using a plurality of nomograms comprising the characteristics and a plurality of competing risk factors, using a processor programmed to calculate risk scores from one or a plurality of nomograms comprising patient characteristics and competing risk factors, determining the patient's prognosis based on the risk score, and, treating the patient with a treatment regimen capable of improving the prognosis of a cancer patient, for example, improving the prognosis of a genitourinary cancer patient. The genitourinary cancer may comprise bladder cancer, kidney cancer, penile cancer, prostate cancer, renal pelvis and ureter cancer, testicular cancer, urethral cancer, ureteral cancer, or adrenal cancer. Renal cell carcinoma is a preferred example of a kidney cancer.

The characteristics may comprise any preoperative or postoperative characteristics. The characteristics may comprise physical characteristics, and may comprise one or more of race, ethnicity, sex, age at diagnosis, family history, histological subtype, grade, stage of cancer, size of tumor, presence and type of tumor markers, presence of necrosis, tumor vascularization, level of tumor antigens in a biological fluid such as blood, degree of metastasis, location of metastasis, descriptors of the tumor's anatomic complexity, percutaneous biopsy data, radiographic imaging characteristics, growth kinetics, or a gene expression profile, and including any combination thereof.

The competing risk factors may comprise a comorbidity, a noncancer death, death from a cancer other than a genitourinary cancer, death from another genitourinary cancer, or one or more treatments for a genitourinary cancer. The competing risk factors may comprise at least one of an unintentional injury, fall, ischemia, heart disease, heart attack, peripheral vascular disease, cerebrovascular disease, stroke, chronic obstructive pulmonary disease (COPD), respiratory disease, bronchitis, diabetes, pneumonia, septicemia, suicide, influenza, other infectious disease (e.g., a viral, bacterial, parasitic, or fungal infection), dementia, neurodegenerative disease, kidney disease, liver disease, hepatitis, hypertension, or gastrointestinal disease, or any combination thereof.

The prognosis may comprise a substantial likelihood of mortality within about ten years. The prognosis may comprise a substantial likelihood of mortality within about five years. The prognosis may comprise a substantial likelihood of mortality within about three years. The prognosis may comprise a substantial likelihood of mortality within about two years. The prognosis may comprise a substantial likelihood of mortality within about one year.

The treatment regimen may comprise at least one of surgery, radiation therapy, proton therapy, ablation therapy, hormone therapy, chemotherapy, stem cell therapy, follow up testing, diet management, vitamin supplementation, nutritional supplementation, exercise, physical therapy, prosthetics, use of implants or medical devices, reconstruction, psychological counseling, social counseling, education, or regimen compliance management, or any combination thereof. The treatment regimen may be capable of improving the prognosis of a genitourinary cancer patient having substantially the same risk score as the calculated risk score.

The methods may comprise repeating the calculating and determining steps after a period of time. The period of time may be about six months. The period of time may be about one year. The period of time may be about five years. The methods may further comprise repeating the treating step based on the newly calculated risk score or newly determined prognosis, which may comprise a different treatment than the original treatment provided to the patient. The methods may further comprise monitoring the treatment regimen. The methods may further comprise comparing the risk score with a risk score previously obtained from the patient, a risk score from a healthy population, a risk score from a population with a stage I, II, III, or IV cancer, including in some aspects a population with a stage I, II, III, or IV genitourinary cancer, a risk score from a healthy population at low risk, moderate risk, or high risk for developing a genitourinary cancer, and/or a risk score from a population with a genitourinary cancer in remission, and determining the patient's prognosis based on the comparison.

The invention also features systems for managing the care of a cancer patient, for example, the care of a genitourinary cancer patient. In general, the systems comprise at least one data structure comprising at least one nomogram comprising characteristics of patients having the cancer of interest, for example, characteristics of genitourinary cancer patients, and comprising competing risks, and a processor capable of calculating a risk score from the characteristics and the nomograms. The data structure and processor are preferably operably connected. The processor may be a computer processor, and may be comprised in a computer. The systems may further comprise a computer programmed to determine the prognosis of a cancer patient, for example, the prognosis of a genitourinary cancer patient, from the risk score, which may be the same computer used to calculate a risk score. The systems may further comprise a standard of care checklist. The system may further comprise a computer network connection. The systems may be used, for example, in methods for managing the care of a cancer patient.

The invention also features computer-readable media. In general, the computer-readable media comprise executable code for causing a programmable processor to assign values to each of a plurality of patient characteristics, executable code for causing a programmable processor to introduce the values into a plurality of nomograms comprising characteristics of cancer patients, for example, characteristics of genitourinary cancer patients, and competing risks, and executable code for causing a programmable processor to calculate a risk score from the introduction of the values into the nomograms. The media may further comprise executable code for causing a programmable processor to determine a prognosis based the risk score. The media may further comprise executable code for causing a programmable processor to recommend a treatment regimen for managing the care of a cancer patient, for example, a genitourinary cancer patient, having the risk score. The media may further comprise a processor, which may be programmable. The computer readable media may be used, for example, in systems and/or in methods for managing cancer patient care.

### BRIEF DESCRIPTION OF THE DRAWINGS

FIG. 1 shows marginal cumulative incidence curves with 95% CIs for the three types of death included in the predictive model.

FIG. 2 shows the predicted probability of (A) overall survival by age shown using Kaplan-Meier curve, (B) kidney cancer-specific survival (determined using codes 29010, 29020, 29030, and 29040) by tumor size shown using (1-) cumulative incidence function, and (C) non-kidney cancer specific survival by race shown using (1-) cumulative incidence function.

FIG. 3 shows calibration after grouping individuals by decile of regression predicted 5-year probabilities.

FIG. 4 shows a nomogram evaluating 5-year competing risks of death in patients with localized renal cell carcinoma. Total point values are independently calculated for each cause of death and then applied to the corresponding probability scale at the bottom of the figure. For example, a 75-year old white male with a 4-cm tumor would have a 5-year mortality of 5% (80 points) from RCC versus 4.5% (114 points) from other cancers and 14% (91 points) from noncancerous causes.

FIG. 5 shows an example of a standard of care checklist.

FIG. 6A shows an example of a post-surgery standard of care checklist. FIG. 6B shows a flow chart for patient risk assessment.

FIG. 7 shows a non-limiting example of a system for managing the care of a cancer patient.

### DETAILED DESCRIPTION OF THE INVENTION

Various terms relating to aspects of the invention are used throughout the specification and claims. Such terms are to be given their ordinary meaning in the art, unless otherwise indicated. Other specifically defined terms are to be construed in a manner consistent with the definition provided herein.

As used herein, the terms “a,” “an,” or “the” include plural referents.

The terms “subject” or “patient” are used interchangeably and refer to any animal, with humans being highly preferred.

It has been observed in accordance with the invention that competing risk proportional hazard regression statistics can be used to predict 5-year probability of competing mortality outcomes in renal cell carcinoma patients. Various factors were integrated into a nomogram capable of quantitating competing causes of mortality. This nomogram is a tool capable of estimating risks within 5 years from diagnosis of renal cell carcinoma, and can be used in connection with other nomograms to generate information to guide and manage patient care. Accordingly, the invention features methods for managing cancer patient care. In preferred aspects, the invention features methods for managing genitourinary cancer patient care.

In some aspects, the methods comprise calculating a risk score from characteristics obtained from a cancer patient, for example, a genitourinary cancer patient, by input of the characteristics into a plurality of nomograms which comprise these characteristics as well as at least one competing risk factor, and determining the patient's prognosis based on the calculated risk score, and optionally, treating the patient with a regimen capable of significantly improving the prognosis of a cancer patient, for example, a genitourinary cancer patient, having substantially the same risk score as the calculated risk score. The calculating and/or determining aspects of the methods are preferably carried out using a processor capable of calculating risk scores and/or determining a prognosis. In some preferred aspects, the processor comprises a computer (or itself is comprised within a computer) that is programmed to calculate risk scores and/or programmed to determine a prognosis.

The methods may be used in accordance with any cancer, with genitourinary cancer being highly preferred. Non-limiting examples of general categories of genitourinary cancers include bladder cancer, kidney cancer, penile cancer, prostate cancer, renal pelvis and ureter cancer, testicular cancer, urethral cancer, ureteral cancer, and adrenal cancer. Renal cell carcinoma, being exemplified, is a preferred type of a kidney cancer.

Characteristics include any data, measurements, or information that can be obtained from or about the patient, such as by questionnaire, medical records, physical inspection or examination, biopsy, surgery, test, or assay. The characteristics preferably are obtained by a medical practitioner. By way of example, but not of limitation, characteristics can include race, ethnicity, sex, age at diagnosis, family history, histological subtype, grade, stage of cancer, size of tumor, presence and type of tumor markers, presence of necrosis, tumor vascularization, level of tumor antigens in a biological fluid such as blood, degree of metastasis, location of metastasis, descriptors of the tumor's anatomic complexity, percutaneous biopsy data, radiographic imaging characteristics, growth kinetics, and other characteristics relevant to calculating a risk score. The calculation may include any number of characteristics, preferably at least one, and more preferably a plurality of characteristics. The characteristics may be obtained at any time prior to the patient receiving any treatment such as surgery, e.g., preoperative, at any time during treatment, and/or at any time after the patient receives any treatment such as surgery, e.g., postoperative.

In some aspects, the characteristics comprise genetic information, including one or more gene expression or differential expression profiles. With the advancement of fields such as pharmacogenomics, increasing interest in a patient's genetic makeup and on gene expression profiles has arisen. In fact, numerous studies have been undertaken or are ongoing to determine gene expression profiles for all manner of conditions, including genitourinary cancers. Thus, one or more gene expression profiles may be obtained from the genitourinary cancer patient and utilized in the inventive methods. The gene expression profile may relate to any aspect, including the stage, of the genitourinary cancer.

Tests to detect genetic abnormalities may also be used. Such tests are commercially available, and include without limitation the UroVysion® (Abbot Laboratories, IL) and NMP22® BladderCheck® (Matritech, Inc., DE) bladder cancer tests.

Gene expression profiles of various aspects of genitourinary cancers are published and publicly available, and the skilled practitioner would be expected to be able to identify particular gene expression profiles to obtain from the patient according to any relevant criteria. Similarly, as new gene expression profiles are developed and published, they too could be used by the skilled practitioner as a characteristic obtainable from the genitourinary cancer patient, and could thus be used in accordance with the methods described and exemplified herein.

The patient characteristics are introduced into at least one, and preferably a plurality of nomograms that comprise the characteristics obtained from the patient and comprise at least one, and preferably a plurality of competing risks. Each individual nomogram need not comprise all of the patient characteristics and competing risks, and it is sufficient if the plurality of nomograms comprises characteristics and competing risks of interest.

The nomograms may be stored as part of an electronic data structure such as a database, including any processor or computer, for example, a computer programmed to calculate a risk score. Thus, for example, a user may enter selected patient characteristics into a computer that can calculate or otherwise assign a value for each characteristic, can input that value into one or more nomograms, and can then calculate a risk score from the nomogram based on the value of each characteristic in view of the values for competing risk factors. It is contemplated that over time, further statistical studies will generate additional information and nomograms for new and/or different combinations of patient characteristics and competing risk factors. Newly generated nomograms can be added to the database, and can thus be used in accordance with the methods described and exemplified herein.

Nomograms may be selected for inclusion in the database according to the following non-limiting criteria: (1) clinical utility of input characteristics; (2) clinical relevance; (3) cohort size; (4) validation status; (5) Area under the curve (AUC)/c-index; and, (6) quality of journal where the publication was published. Nomograms may be excluded if a more recent, better-powered, and/or more relevant nomogram has been published since the date of the original nomogram's publication, or if the nomogram is otherwise incomplete, insufficient, or unreliable.

In general, a risk score comprises a statistical probability of a particular event occurring or not occurring. For example, the risk score may comprise the probability of death from the particular cancer being screened, for example, a genitourinary cancer, the probability of death from a different cancer, or the probability of a noncancer death. A risk score can be expressed in any suitable units. In some aspects, the risk score may comprise the probability of advancement of the cancer. For example, the U.S. National Cancer Institute classifies cancer according to five basic stages, Stage 0, Stage I, Stage II, Stage III, and Stage IV, based on the TNM scoring system (Primary Tumor, Regional Lymph Nodes, and Distant Metastasis). Thus, the risk score can represent the probability that the cancer will advance to a later stage.

The nomograms comprise at least one competing risk factor, and in some aspects, comprise a plurality of competing risk factors. In general, competing risk factors comprise any factors that may impact the patient's prognosis with respect to the cancer, for example, genitourinary cancer. In some aspects, a competing risk factor is a competing cause of death. Thus, for example, a competing risk factor may be any event, disease, disorder, morbidity, comorbidity, or illness that may cause mortality in the genitourinary cancer patient independently of the genitourinary cancer and before the genitourinary cancer causes mortality. Competing risk factors may be those which are capable of accelerating mortality from the genitourinary cancer or any of its known complications. Competing risk factors may be other cancers, or may be noncancer factors. Competing risk factors may be revealed from any gene expression profile or genetic test carried out on the patient.

Non-limiting examples of noncancer competing risk factors include the following: accidents/unintentional injuries, falls, ischemia, heart disease, heart attacks, peripheral vascular disease, cerebrovascular disease, stroke, chronic obstructive pulmonary disease (COPD), respiratory disease, bronchitis, diabetes, pneumonia, septicemia, suicide, influenza, other infectious disease (e.g., viral, bacterial, parasitic, or fungal infection), dementia (e.g., Alzheimer's disease), neurodegenerative diseases (e.g., Multiple Sclerosis), kidney disease, liver disease, hepatitis, hypertension, other malignancies, and gastrointestinal disease, including any specific or subtypes of the general categories outlined above, and including combinations thereof.

In parts of the world with significant rates of endemic disease or with populations in war zones, risks of death from infectious etiologies and/or violence may be integrated into the competing risks models. Thus, noncancer competing risk factors may include population- or region-specific events and factors.

Noncancer competing risk factors may further include risks from a particular course of treatment for the cancer of interest, for example, genitourinary cancer. For example, such risk factors include complications or death from surgery, radiation therapy, proton therapy, hormonal therapy, photodynamic therapy, ablation therapy, and/or a particular chemotherapeutic agent or combination of agents. Death from complications need not occur immediately and may occur after any period of time. A non-limiting example of this latter type is a delayed thromboembolic event that occurs several weeks following the initial treatment.

Cancer competing risk factors include any specific type of cancer, which the skilled practitioner would be expected to know or determine. A cancer competing risk may be another cancer arising spontaneously in the patient. Thus, cancer competing risks comprise at least one other cancer in the patient. The other cancer may be a genitourinary cancer or another type of genitourinary cancer.

Based on information generated by introducing patient characteristics into the nomograms, e.g., a risk score, a prognosis for the patient can be determined. In some aspects, a prognosis comprises a predicted course for the cancer, for example, a genitourinary cancer, including probabilities of the rate and extent of advancement, including metastasis. In some aspects, a prognosis comprises a predicted outcome for the cancer, for example, a genitourinary cancer, including chances of death from the cancer or related morbidity arising as a complication of the cancer, and including chances of remission or recovery. In some aspects, a prognosis comprises a predicted probability of death from one or more competing risk factors, including a cancer treatment or course of treatments. In some aspects, a prognosis comprises a predicted chance of remission or recovery based on a particular treatment regimen, which may comprise one or more of surgery, ablation therapy, chemotherapy, hormone therapy, photon therapy, immunotherapy, radiation therapy, and combinations thereof, and other clinically acceptable cancer treatment regimens.

A prognosis may relate to, or be measured according to any time frame. By way of example, but not of limitation, a prognosis may comprise the probability of death from the cancer, for example, a genitourinary cancer, within five years. In some aspects, the prognosis comprises about a three month period of time. In some aspects, the prognosis comprises about a six month period of time. In some aspects, the prognosis comprises about a twelve month period of time. In some aspects, the prognosis comprises about an eighteen month period of time. In some aspects, the prognosis comprises about a two year period of time. In some aspects, the prognosis comprises about a three year period of time. In some aspects, the prognosis comprises about a four year period of time. In some aspects, the prognosis comprises about a five year period of time. In some aspects, the prognosis comprises about a ten year period of time. In some aspects, the prognosis comprises an about one to about three year range of time. In some aspects, the prognosis comprises an about two to about five year range of time. In some aspects, the prognosis comprises an about three to about five year range of time. In some aspects, the prognosis comprises an about three to about ten year range of time. In some aspects, the prognosis comprises an about five to about ten year range of time. Time frames may be shorter than three months or may be longer than five years or longer than ten years. Time frames may vary according to clinical standards, or according to the needs or requests from the patient or practitioner.

In some aspects, a prognosis is determined using a computer programmed to determine a prognosis using risk scores and nomograms such as those described or exemplified herein. Such a computer may access or otherwise be integrated with a database or other type of data structure comprising nomograms. Separate computers for calculating risk scores and for determining prognoses may be used.

A desirable goal is to improve the cancer patient's prognosis. Thus, the prognosis may dictate, or at least suggest or otherwise lend itself to a particular course of treatment and follow-up care that would produce a clinically significant improvement in the patient's outcome, or at least quality of life, over a period of time. Improvements may be measured according to any suitable metric, including enhanced length of life, enhanced quality of life, or improved mental or emotional well-being, as determined by any suitable means such as a repeat test of the inventive methods, a physical examination, a psychological examination, survey, or other such way of determining improvements in the patient's prognosis. In some aspects, an improvement may be determined according to a risk score calculated according to the inventive methods.

The prognosis may suggest that a particular treatment is contraindicated, for example, because the risk of the treatment is significantly greater than the risk of the cancer itself. Thus, in some aspects, a particular treatment may be considered a competing risk, which may be included in one or more nomograms used to calculate a risk score. For example, patients of advanced age may have a significantly high risk of dying from surgery, meaning that surgery may be contraindicated as part of a treatment regimen for that patient.

Treatment regimens may be directed at eliminating or reducing the size of the tumor, slowing or preventing advancement of the cancer, pain management, appetite stimulation, and/or general quality of life management. Treatment regimens may be directed at avoiding or preventing the competing risk, or at least in reducing the statistical likelihood of the competing risk materializing. Treatment regimens may be directed to personal goals of a particular patient or practitioner managing the patient's care. Treatment regimens may be standardized or may comprise treatments accepted as improving the prognosis of cancer patients such as genitourinary cancer patients with similar prognoses and/or similar risk scores. In general, treatment may comprise one or more of surgery, radiation therapy, proton therapy, ablation therapy, hormone therapy, chemotherapy, stem cell therapy, follow up testing, diet management, vitamin supplementation, nutritional supplementation, exercise, physical therapy, prosthetics, use of implants or medical devices, reconstruction, psychological counseling, social counseling, education, regimen compliance management, and combinations thereof, and other known aspects of improving cancer patient prognoses.

Treatment regimens, whether targeted to the cancer of interest such as a genitourinary cancer, the competing risk, or both, may be personalized, may vary among different patients, and may vary with or be adjusted for individual patients over time. Variations may include, for example, increasing the type, dosage, and/or frequency of a particular chemotherapeutic agent or nutritional supplement, or fine tuning of other therapies. Variations may relate to, among other things, the age, sex, physical condition, physical health, cancer stage, mental health, emotional health, untoward effects, level of response—positive or negative, or lack thereof—to any particular aspect of the regimen, patient performance status, patient comorbidity status, margin status at resection, and receipt of neoadjuvant and/or adjuvant chemo/radiation therapy.

The inventive methods may optionally be repeated. Thus for example, in some aspects, the methods optionally further comprise repeating the calculating of a risk score and the determining of a prognosis after a period of time. Repeating the methods may be used, for example, to determine if the patient's prognosis has improved based on the treatment regimen, or to determine if adjustments to the treatment regimen should be made to achieve improvement or to attain further improvement in the patient's prognosis. The methods may be repeated at least one time, two times, three times, four times, or five or more times. The methods may be repeated as often as the patient desires, or is willing or able to participate.

The period of time between repeats may vary, and may be regular or irregular. In some aspects, the methods are repeated in three month intervals. In some aspects, the methods are repeated in six month intervals. In some aspects, the methods are repeated in one year intervals. In some aspects, the methods are repeated in two year intervals. In some aspects, the methods are repeated in five year intervals. In some aspects, the methods are repeated only once, which may be about three months, six months, twelve months, eighteen months, two years, three years, four years, five years, or more from the initial assessment.

In some aspects, the patient's risk score may be compared with a risk score previously obtained for the patient and/or with a risk score based on population information. Such a comparison may provide a higher confidence level for the prognosis determined from the risk score. Thus, for example, the calculated risk score may be compared with a risk score previously obtained from the patient, a risk score from a healthy population, a risk score from a population with a stage I, II, III, or IV cancer such as a genitourinary cancer, a risk score from a healthy population at low risk, moderate risk, or high risk for developing a cancer such as a genitourinary cancer, and/or a risk score from a population with a cancer such as a genitourinary cancer in remission. The prognosis may therefore be determined based on the comparison.

The methods may optionally further comprise monitoring the patient's treatment regimen. Monitoring may be used to ensure patient compliance, to identify and correct any mistakes in aspects of the treatment regimen, to identify and correct complications experienced by the patient, or to ensure patient satisfaction with the care received. For example, monitoring may comprise the use of standard of care checklists that comprise information to ensure proper testing was done and proper treatments were prescribed. Monitoring may comprise a regimen of follow up visits with the patient. Monitoring may comprise screening for untoward effects of the treatment regimen on the patient. Information gained from monitoring the patient may be used to fine tune the treatment regimen.

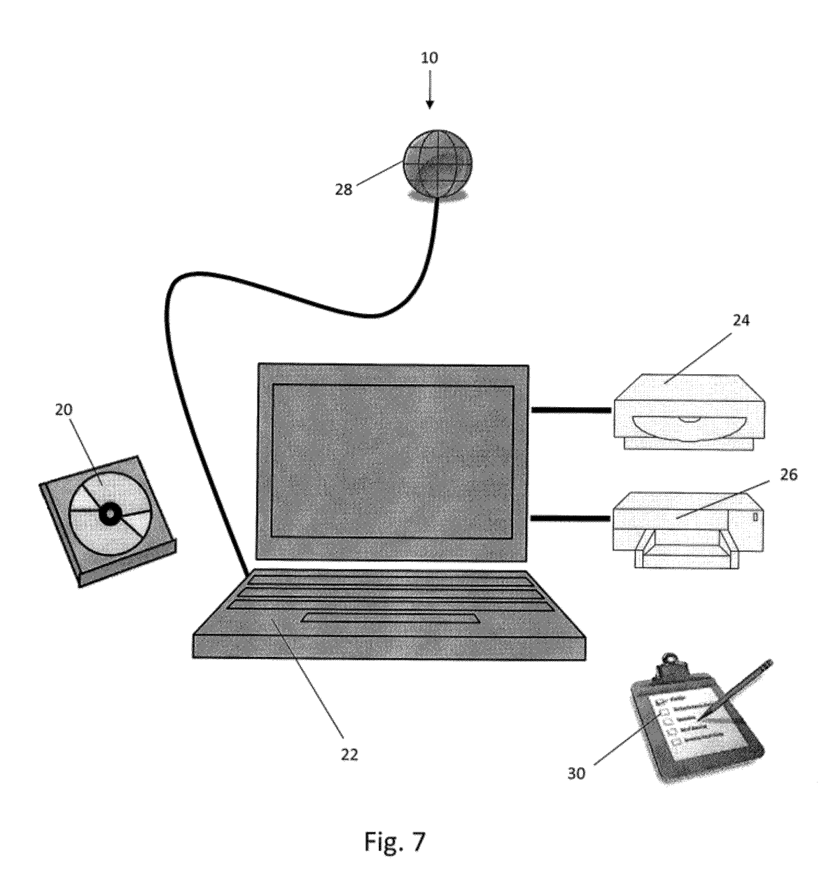

The invention also features systems 10 for managing the care of cancer patients (FIG. 7), for example, managing the care of genitourinary cancer patients. In some aspects, the systems 10 comprise a data structure 20 comprising nomograms comprising characteristics of cancer patients such as genitourinary cancer patients and comprising competing risks. The data structure 20 may comprise a programmable processor 22 such as a computer, and/or computer network connection 28. The systems 10 may comprise a processor 22 or a computer programmable or programmed to calculate a risk score from characteristics obtained from cancer patients and from nomograms comprising characteristics of cancer patients and competing risks. The systems 10 may comprise a processor 22 or a computer programmable or programmed to determine the prognosis of a cancer patient from a risk score calculated from characteristics obtained from cancer patients and from nomograms comprising characteristics of cancer patients and competing risks. The cancer patients may be genitourinary cancer patients. The systems 10 may comprise a graphical user interface. The systems may comprise an input 24 for accepting data, such as patient characteristics, entered into the system. The systems may comprise an output 26 for providing information to a user. Such information may, for example, be a risk score and/or prognosis. The user may be a patient or a medical practitioner. The systems 10 may be used to carry out any method described or exemplified herein.

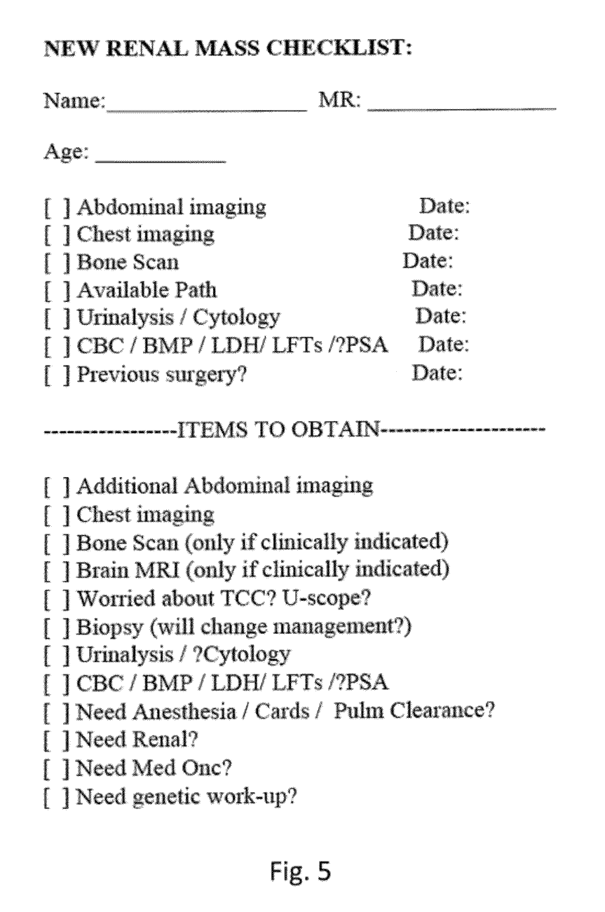

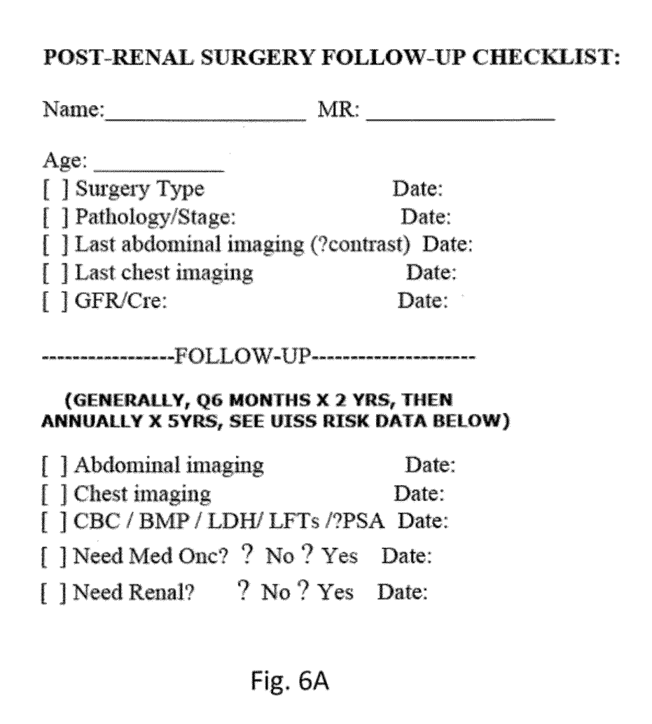

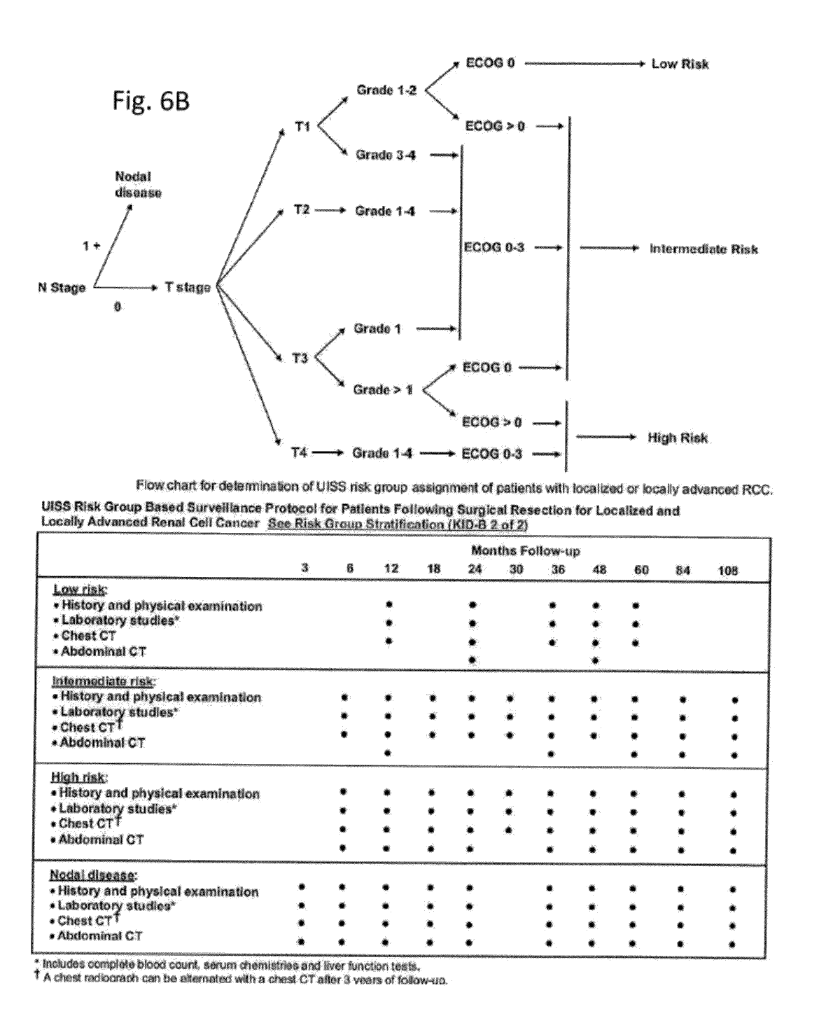

The systems 10 may further comprise a standard of care checklist 30, for example, checklists for adherence to National Comprehensive Cancer Network (NCCN) or American Urological Association (AUA) guidelines. Non-limiting examples of standard of care checklists include those shown in FIGS. 5 and 6.

The invention also features computer-readable media programmed with executable code for performing a method of managing cancer patient care, for example, a method of managing genitourinary cancer patient care. A computer readable medium may comprise executable code for causing a programmable processor to assign a value to a patient characteristic, code for causing a programmable processor to introduce the value into a plurality of nomograms comprising characteristics of cancer patients, for example, genitourinary cancer patients, and competing risks, code for causing a programmable processor to calculate a risk score from the introduction of a plurality of patient characteristic values into a plurality of nomograms. A computer readable medium may comprise executable code for causing a programmable processor to determine a prognosis based on a calculated risk score. A computer readable medium may comprise executable code for causing a programmable processor to recommend a treatment regimen for managing the care of a cancer patient, for example, a genitourinary cancer patient, having a particular risk score. A computer readable medium may comprise executable code for causing a programmable processor to check a determined prognosis and/or treatment regimen against a standard of care checklist. A computer readable medium may comprise a processor, and the processor may be programmable. The computer readable media may be used to carry out any method described or exemplified herein.

The following examples are provided to describe the invention in greater detail. They are intended to illustrate, not to limit, the invention.

### Example 1

### Experimental Methods

Using the Surveillance, Epidemiology, and End Results (SEER) registry (1988 through 2003), 32,677 individuals ≧30 years of age with localized Renal Cell Carcinoma (RCC) RCC ≦20 cm in diameter from 17 geographic regions were identified. Patients (n=1,876) who had SEER codes indicating that either no cancer-directed surgery was performed or it was unknown whether cancer-directed surgery was performed were excluded. The remaining 30,801 patients formed the cohort. The 30,801 patients included only those with common histologic subtype codes: clear-cell (n=27,527), papillary (n=1,494), chromophobe (n=712), adenocarcinoma (n=254), or granular (n=814). To eliminate most childhood renal tumors, individuals younger than 30 years of age were excluded. Also excluded from the analysis were all tumors greater than 20 cm, given their association with metastases, unusual histologies, and local symptoms. Individuals, who under the SEER “Reason for no surgery” field were indicated to have had partial nephrectomy, nephrectomy, ablation (uncommon before 2000), or surgery not otherwise specified were included.

The Kaplan-Meier product-limit method was used to describe overall survival and the log-rank test for overall survival differences. The cumulative incidence function (CIF) was used to describe cause-specific survival and Gray's test to test for cause-specific survival differences. Cause of death was classified as either kidney cancer related, other cancer related, or non-cancer related.

Fine and Gray competing risks proportional hazards regressions were used to predict 5-year probabilities of the three competing mortality outcomes. The Fine and Gray model is a multivariable time-to-event model, which accounts for the fact that individuals can only have one of the three competing events. The model also accounts for censoring among those who do not have an event during follow-up.

In developing the nomogram, model coefficients were used to assign points to characteristics and predictions from the model to map cumulative point totals for each outcome to 5-year survival predictions. Prognostic markers included race, sex, histologic subtype, tumor size, and age. Grade was not incorporated into the model because approximately 40% of the sample had missing grade data, and raised concerns about missing data bias. The year of diagnosis was accounted for in the models and it was assumed that the current year of diagnosis effect is the same as the effect of the last year of diagnosis in the data (2003). Restricted cubic splines with three knots at the 10%, 50%, and 90% empirical quantiles were used to model continuous variables. Wald tests of coefficients were used to determine statistical significance (p<0.05).

To assess the predictive accuracy of our model, the calibration method of Kattan was adapted (Kattan M W et al. (2003) Stat. Med. 22:3515-25). For each individual, the probability of each outcome at 5 years after was predicted by fitting the competing risk regression using data only from the other 30,800 individuals. The model predicted probabilities were then averaged within deciles defined by the magnitude of the predictions. Within each decile of individuals, the marginal cumulative incidence of death was estimated using methods described by Gray (Gray R J (1988) Ann. Stat. 16:1141-54). Marginal estimates versus model average predictions were plotted. In a well-calibrated model, the predictions should fall on a 45-degree diagonal line.

For survival analyses, R (R Foundation for Statistical Computing, Vienna, Austria; www.r-project.org) and its cmprsk package were used.

### Example 2

### Experimental Results

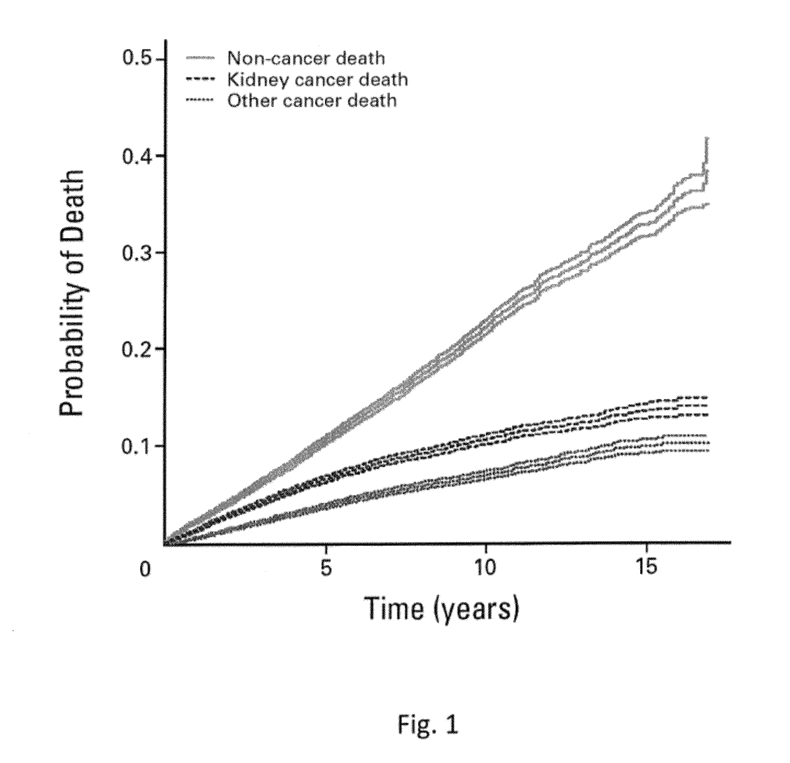

Kidney Cancer Death and Competing Risk Analysis. The demographics for the cohort of 30,801 patients and probabilities of death are provided in Table 1. FIG. 1 depicts marginal cumulative incidence curves for the three types of death included in the analysis. The majority of the sample were male (61%), white (84%), and had clear-cell histology (92%). The median age at diagnosis was 62 years (range, 30 to 96 years). Median tumor size was 4.5 cm (range, 0.1 to 20 cm by design). More than half the sample (53%) were diagnosed between 2000 and 2003, with 25% diagnosed between 1995 and 1999 and 22% between 1988 and 1994. The median length of follow-up until censoring or death was 3.8 years (range, 0 to 203 months); however, 9,256 individuals had 6 or more years of follow-up, demonstrating the total number of individuals with long-term follow-up to be significant. At last contact, 75% were censored, whereas 25% died, with 7% (2,149) dying from kidney cancer, 4% (1,353) dying from other cancers, and 13% (4,145) dying from other causes. Factors associated with prolonged survival included younger age, non-African American race, and smaller tumors (Table 1).

TABLE 1
Probability of Death.
Probability of Death

| | | Non-Cancer | | | | Kidney Cancer | | | Other Cancer | | |
|---|---|---|---|---|---|---|---|---|---|---|---|
| | | | 5 | 10 | p- | 5 | 10 | p- | 5 | 10 | p- |
| | | N | year | year | value | year | year | value | year | year | value |
| All Patients | | 30,801 | 11% | 22% | | 4% | 7% | | 7% | 11% | |
| Race | | | | | <0.001 | | | 0.137 | | | 0.002 |
| | Black | 3,199 | 15% | 30% | | 6% | 8% | | 4% | 7% | |
| | White | 26,009 | 10% | 21% | | 7% | 11% | | 4% | 7% | |
| | Other | 1,593 | 9% | 19% | | 6% | 10% | | 2% | 4% | |
| Sex | | | | | <0.001 | | | 0.003 | | | <0.001 |
| | Male | 18,773 | 11% | 22% | | 7% | 11% | | 4% | 8% | |
| | Female | 12,028 | 9% | 22% | | 6% | 10% | | 3% | 6% | |
| Age at Diagnosis | | | | | <0.001 | | | <0.001 | | | <0.001 |
| | <50 | 5,822 | 3% | 7% | | 4% | 7% | | 1% | 2% | |
| | 50-64 | 11,180 | 7% | 14% | | 6% | 10% | | 3% | 5% | |
| | 65-74 | 8,448 | 12% | 27% | | 7% | 11% | | 6% | 10% | |
| | 75-84 | 4,841 | 21% | 45% | | 9% | 13% | | 6% | 11% | |
| | 85+ | 510 | 37% | 66% | | 11% | 16% | | 8% | 9% | |
| Size | | | | | <0.001 | | | <0.001 | | | 0.006 |
| | <4 cm | 12,503 | 11% | 24% | | 3% | 5% | | 4% | 7% | |
| | 4-7 cm | 12,570 | 11% | 23% | | 7% | 11% | | 4% | 7% | |
| | >7 cm | 5,728 | 8% | 16% | | 13% | 21% | | 3% | 6% | |

Patient characteristics and probabilities of death. P-values correspond to comparisons among groups within outcomes of the underlying subdistribution hazards used to estimate the probabilities

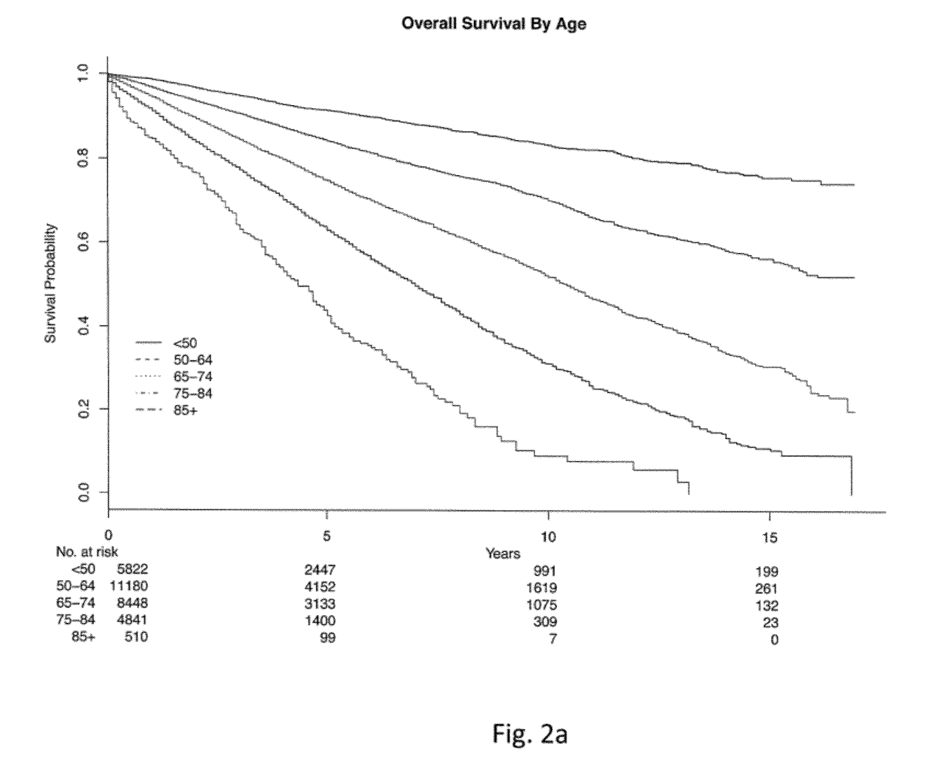

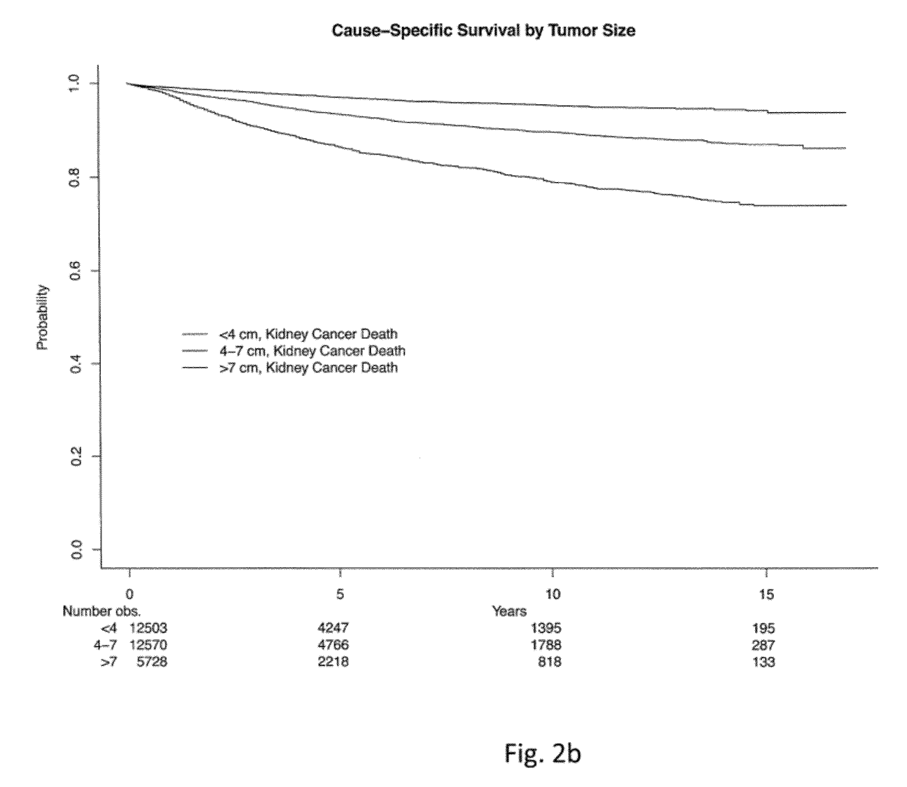

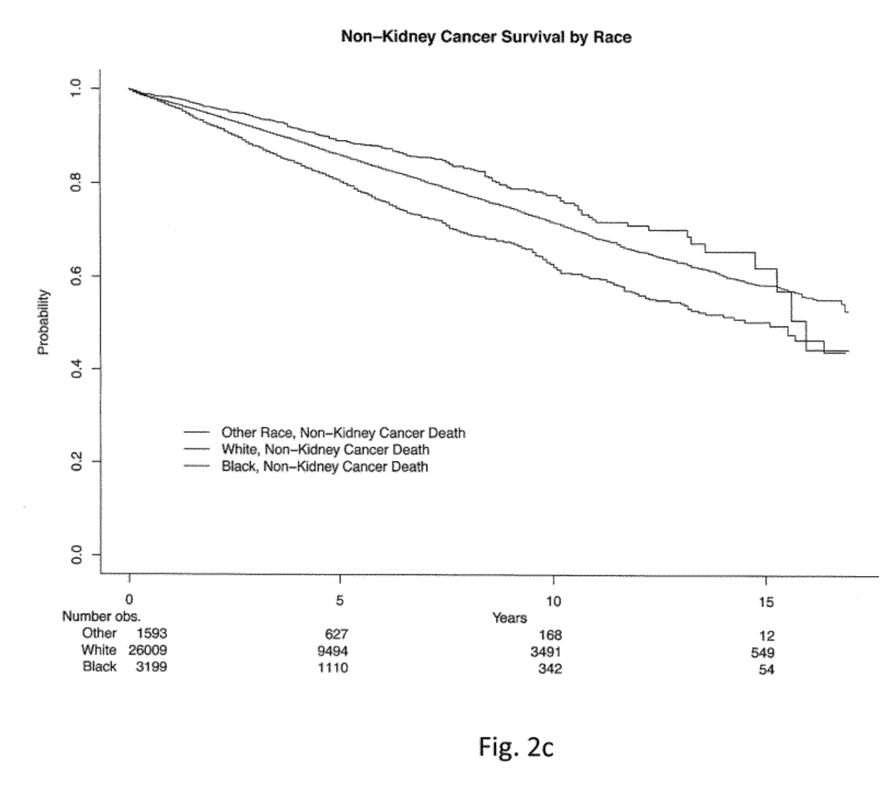

Age was strongly predictive of mortality and most predictive of non-kidney cancer deaths (P<0.0001 for the first spline term for all three outcomes). Increasing tumor size was related to death from kidney cancer and inversely related to death from other causes (P<0.04 for the first spline coefficient for all three outcomes). Racial differences in outcomes were more pronounced for nonkidney cancer deaths (P<0.002 for a test of equality of the race coefficients only for the two nonkidney cancer death outcomes; FIG. 2). Men were more likely to die than women from all causes (P<0.002 for all outcomes).

The histologic subtype effect was not statistically significant or clinically relevant in the models (P>0.05 for all outcomes). Hence we left histologic subtype out of the final nomogram model.

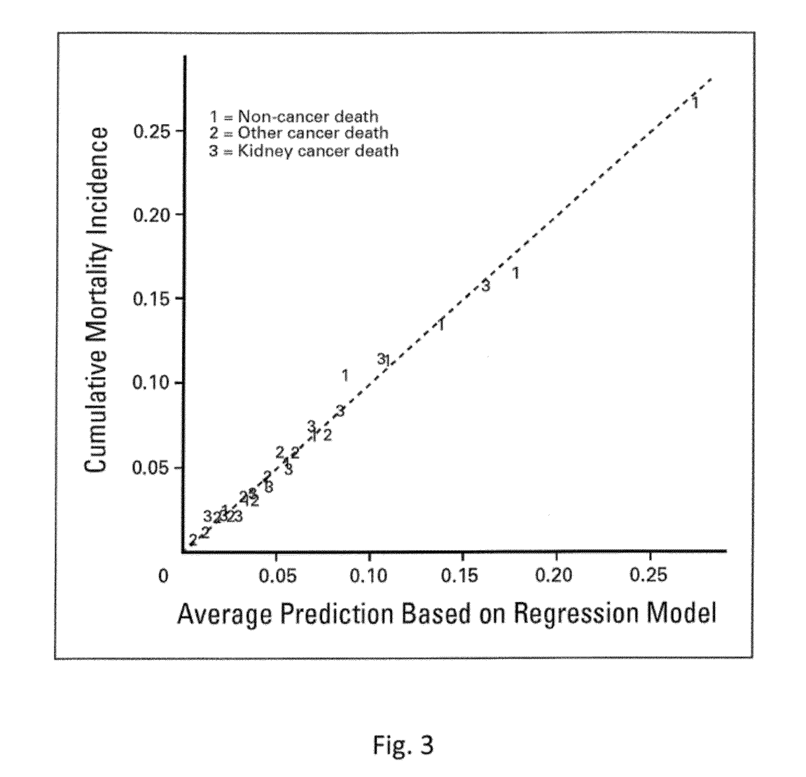

Nomogram. A nomogram was constructed to facilitate simultaneous integration of the previously mentioned factors in the calculation of competing risks of death into a useful clinical tool. Model selection techniques were not used, but a full model, comparable to the work of Kattan et al. (Stat. Med., 2003) was considered. Instead of model selection, restricted cubic splines were used to flexibly model continuous variables. Deciles were used for calibration (rather than quintiles used by Kattan et al. (Stat. Med., 2003)), because enough outcome data was obtained. FIG. 3 presents the results of the model calibration. The model is well calibrated, because the points are close to the 45-degree line.

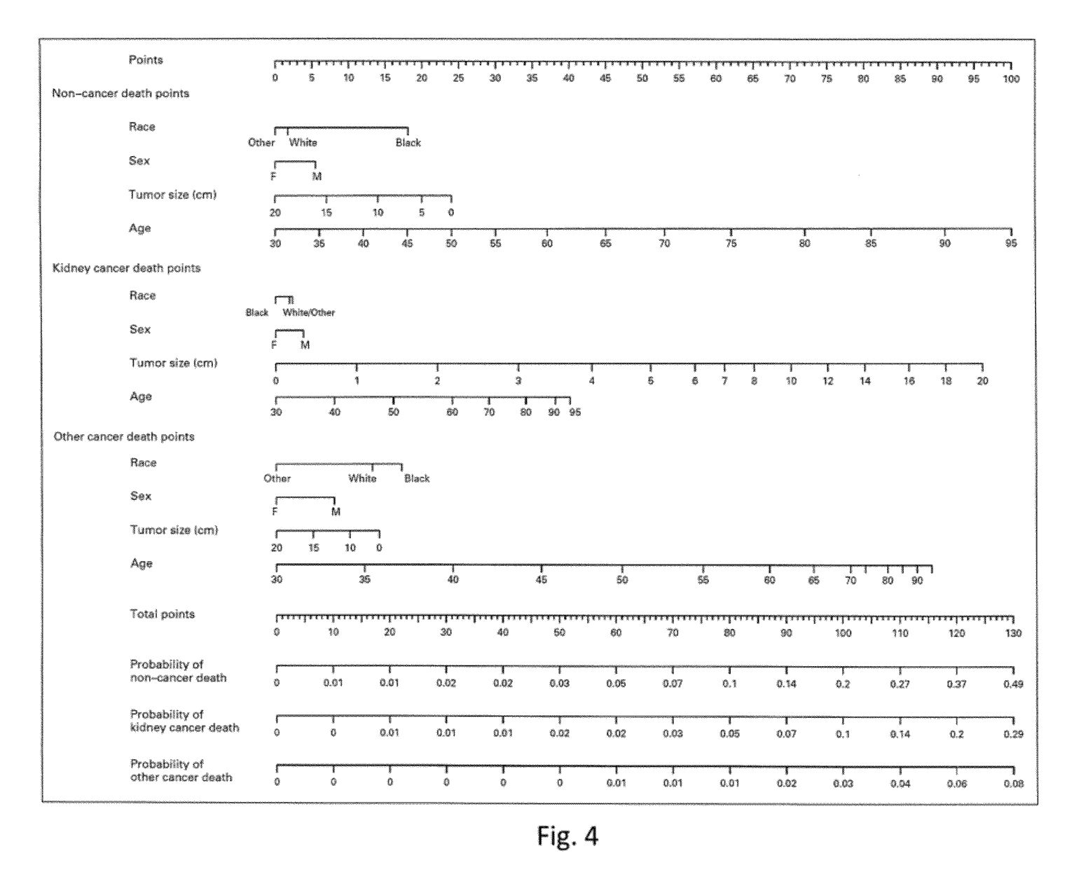

The full nomogram is presented in FIG. 4 and can help physicians identify patients with localized node-negative kidney cancer who may have a high risk of competing causes of death. As such, patients and physicians may use these data to “trade-off” the risk of surgery. For example, using the nomogram, a 75-year-old white male with a 4-cm tumor would have a 5-year mortality rate of 5% (80 points) from RCC versus 5% (115 points) from other cancers and 14% (91 points) from noncancerous causes. Meanwhile, a 65-year-old white male with an 8.5-cm malignancy is predicted to have a 5-year mortality rate of 10% (98 points) from RCC, 4% (106 points) from other cancers, and 6% (68 points) from noncancerous causes.

### Example 3

### Discussion

These studies demonstrate that patients with localized node-negative kidney cancer not only have an excellent 5- (96%) and 10-year (93%) cancer-specific survival, but a significant 5- and 10-year overall risk of death from other cancer deaths (7%, 11%) and non-cancer-related mortality (11%, 22%).

This multivariable model is based on more than 30,000 patients from the SEER database who underwent surgical treatment for localized RCC. The nomogram affords the clinician and patient an opportunity to quantitate three competing 5-year mortality outcomes: (1) death from RCC, (2) death from other (non-RCC) malignancies, and (3) noncancer death. The value of this model is its ability to help guide management decisions in the preoperative setting. The model may have utility both for clinical and research purposes. Risk estimates provided by the model can be extremely useful in patient counseling, especially when discussing less aggressive treatment options with elderly or comorbid patients. Moreover, the nomogram can be used in clinical trials designed to evaluate AS protocols for RCC.

Fine and Gray competing risks proportional hazards regressions were used to model the cumulative incidence function (CIF). The CIF for a specific outcome describes the probability of having that outcome over time. For this study, the probability of dying at any time point was the sum of the three probabilities of dying from cause-specific events as estimated by the CIF. A difference between estimators of the CIF compared with the Kaplan-Meier estimator is the accounting of censoring. In Kaplan-Meier estimation, those who have competing events are censored, and such censoring is considered noninformative about the competing outcomes. Such noninformative censoring is an unrealistic assumption, because those who die from one cause will never be able to die from another cause. Estimation of the CIF assumes that those who die from one cause will never die from a competing cause. Heuristically, Cox regressions are multivariable models akin to Kaplan and Meier curves in the same way that Fine and Gray proportional hazards regressions are akin to CIFs.

In this model, age was a strong predictor of overall mortality and most predictive of non-RCC deaths. Men were more likely to die from all causes, and tumor size was directly related to death secondary to RCC and inversely related to death from other causes.

Although the nomogram is based on a postoperative data set, it is believed that the model can be used for clinical purposes in the preoperative setting. As such, this model affords a quantitative scaffold on which clinical decisions can be based. Nevertheless, clinicians and patients should note that this model yields a 5-year probability of death from competing causes only if surgery is pursued. Moreover, no predictive model can identify each and every variable important for clinical decision making. Therefore, this model's prediction estimates may be biased toward patients who are acceptable surgical candidates.

The nomogram estimates risk of non-RCC death from variables that include race, sex, tumor size, and age, but does not incorporate patients' comorbidities due to limitations of SEER. The nomogram is capable of estimating risks within 5 years from diagnosis of RCC.

It is believed that this is the first comprehensive nomogram to estimate competing risks of death for an index abdominal cancer (kidney) versus other cancers versus noncancer deaths in a population-based cohort. This tool can serve to quantitate treatment trade-off assumptions and guide management of patients, particularly the elderly or infirm, with localized RCC. It helps address ubiquitous qualitative biases in clinical decision making regarding whether to treat solid renal masses in patients with short- and intermediate term competing risks of death. This nomogram is an important step toward the goal of matching surgical treatment options to the biology of RCC, while accounting for competing survival risks of an individual.

The invention is not limited to the embodiments described and exemplified above, but is capable of variation and modification within the scope of the appended claims.

What is claimed is:

1. A method for managing the care of a cancer patient, comprising:
(a) calculating a risk score from characteristics obtained from a cancer patient with a plurality of nomograms comprising the characteristics and a plurality of competing risk factors, using a processor programmed to calculate risk scores;
(b) determining the patient's prognosis based on the risk score; and,
(c) treating the patient with a treatment regimen capable of improving the prognosis.

2. The method of claim 1, wherein the characteristics comprise race, ethnicity, sex, age at diagnosis, type of cancer, family history, histological subtype, grade, stage of cancer, size of tumor, presence and type of tumor markers, presence of necrosis, tumor vascularization, level of tumor antigens in a biological fluid, degree of metastasis, location of metastasis, descriptors of the tumor's anatomic complexity, percutaneous biopsy data, radiographic imaging characteristics, growth kinetics, or combinations thereof.

3. The method of claim 1, wherein the characteristics are obtained from the patient a suitable period of time after surgical treatment for cancer.

4. The method of claim 1, wherein the characteristics are obtained from the patient a suitable period of time before surgical treatment for cancer.

5. The method of claim 1, wherein the competing risk factors comprise one or more of a comorbidity or a noncancer death.

6. The method of claim 1, wherein the competing risk factors comprise at least one of an unintentional injury, fall, ischemia, heart disease, heart attack, peripheral vascular disease, cerebrovascular disease, stroke, chronic obstructive pulmonary disease (COPD), respiratory disease, bronchitis, diabetes, pneumonia, septicemia, suicide, influenza, viral infection, bacterial infection, parasite infection, fungal infection, dementia, kidney disease, neurodegenerative disease, liver disease, hepatitis, hypertension, and gastrointestinal disease.

7. The method of claim 1, wherein the prognosis comprises a substantial likelihood of mortality within about two years.

8. The method of claim 1, wherein the prognosis comprises a substantial likelihood of mortality within about one year.

9. The method of claim 1, wherein the cancer patient is a genitourinary cancer patient.

10. The method of claim 9, wherein the genitourinary cancer patient has bladder cancer, kidney cancer, penile cancer, prostate cancer, renal pelvis and ureter cancer, testicular cancer, urethral cancer, ureteral cancer, or adrenal cancer.

11. The method of claim 9, wherein the genitourinary cancer patient has renal cell carcinoma.

12. The method of claim 9, wherein the competing risk factors comprise death from a cancer other than a genitourinary cancer.

13. The method of claim 9, wherein the competing risk factors comprise at least one treatment for a genitourinary cancer.

14. The method of claim 1, further comprising repeating steps (a) and (b) after a period of about one year, and optionally repeating step (c) thereafter.

15. The method of claim 1, further comprising comparing the risk score obtained in (a) with at least one of a risk score previously obtained from the patient, a risk score from a healthy population, a risk score from a population with a stage I, II, III, or IV cancer, a risk score from a healthy population at low risk, moderate risk, or high risk for developing a cancer, or a risk score from a population with a cancer in remission, and determining the patient's prognosis based on the comparison.

16. The method of claim 9, further comprising comparing the risk score obtained in (a) with at least one of a risk score previously obtained from the patient, a risk score from a healthy population, a risk score from a population with a stage I, II, III, or IV genitourinary cancer, a risk score from a healthy population at low risk, moderate risk, or high risk for developing a genitourinary cancer, or a risk score from a population with a genitourinary cancer in remission, and determining the patient's prognosis based on the comparison.

17. A system for managing the care of a cancer patient, comprising a data structure comprising a plurality of nomograms comprising characteristics of cancer patients and competing risks, and a processor capable of calculating a risk score from the characteristics and the nomograms operably connected to the data structure.

18. The system of claim 17, wherein the cancer patient is a genitourinary cancer patient and the characteristics of cancer patients are characteristics of genitourinary cancer patients.

19. The system of claim 17, further comprising an input for accepting the characteristics and an output for providing the risk score to a user.

20. The system of claim 17, further comprising a computer readable medium comprising executable code for causing a programmable processor to assign values to each of a plurality of cancer patient characteristics, executable code for causing a programmable processor to introduce the values into a plurality of nomograms comprising characteristics of cancer patients and competing risks, executable code for causing a programmable processor to calculate a risk score from an introduction of the values into the nomograms; optionally comprising executable code for causing a programmable processor to determine a prognosis based on the risk score, and optionally comprising executable code for causing a programmable processor to recommend a treatment regimen for managing the care of a cancer patient having the risk score.

21. The system of claim 20, wherein the cancer patient is a genitourinary cancer patient.

22. The system of claim 17, further comprising a standard of care checklist.

23. The system of claim 17, further comprising a computer network connection.

24. A computer-readable medium, comprising executable code for causing a programmable processor to assign values to each of a plurality of cancer patient characteristics, executable code for causing a programmable processor to introduce the values into a plurality of nomograms comprising characteristics of cancer patients and competing risks, and executable code for causing a programmable processor to calculate a risk score from an introduction of the values into the nomograms.

25. The computer readable medium of claim 24, further comprising executable code for causing a programmable processor to determine a prognosis based on the risk score, and optionally comprising executable code for causing a programmable processor to recommend a treatment regimen for managing the care of a genitourinary cancer patient having the risk score.
